(19) United States
(12) Patent Application Publication
(10) Pub. No.: US 2006/0159511 A1
(43) Pub. Date: Jul. 20, 2006

(54) Applicator for personal care compositions

(75) Inventors: Richard H. Seager, Mystic, CT (US); Alfred J. Astoreca, Annandale, NJ (US)

Correspondence Address: BACHMAN & LAPOINTE, P.C., 900 CHAPEL STREET, SUITE 1201, NEW HAVEN, CT, 06510, US

(73) Assignee: Plastek Industries, Inc.

(21) Appl. No.: 11/035,611

(22) Filed: Jan. 14, 2005

(51) Int. Cl. B43K 5/12; B43K 5/06

(52) U.S. Cl. 401/194; 401/179

(57) ABSTRACT

An applicator apparatus includes a non-liquid composition of at least one of an underarm antiperspirant and an underarm deodorant. A barrel at least partially contains the composition. The apparatus includes means for progressively raising the composition through an outlet of the barrel including means for indicating a remaining amount of the composition.

### BACKGROUND OF THE INVENTION

The invention relates to personal care. More particularly, the invention relates to applicators for underarm antiperspirant and/or deodorant.

A well-developed art exists regarding dispenser/applicators for personal care products. One particular area involves applicators for solid or gel antiperspirant and/or deodorant compositions. Applicators for solid and gel compositions are typically thoroughly similar to each other, with a piston (platform) upwardly movable within a cylinder (barrel) to progressively drive the composition out the barrel upper end. Due to the relative lack of stiffness of many gels, dispensers for such gels commonly include foraminate screen-like applicator elements across the upper end of the barrel. Exemplary applicators are shown in U.S. Pat. Nos. 5,007,755, 6,435,748, and D331,534. U.S. Pat. No. 6,506,369 discloses incorporation of a usage indicator into the composition to provide warning that the applicator is nearly empty.

### SUMMARY OF THE INVENTION

Accordingly, one aspect of the invention involves a personal care apparatus having a non-liquid composition of at least one of an underarm antiperspirant and an underarm deodorant. A barrel at least partially contains the composition. The apparatus includes means for progressively raising the composition through an outlet of the barrel. The means further includes means for indicating a remaining amount of the composition.

The details of one or more embodiments of the invention are set forth in the accompanying drawings and the description below. Other features, objects, and advantages of the invention will be apparent from the description and drawings, and from the claims.

### BRIEF DESCRIPTION OF THE DRAWINGS

FIG. 1 is a partially exploded view of an applicator apparatus.

FIG. 2 is a fully exploded view of the apparatus of FIG. 1.

FIG. 3 is a front view of a second applicator apparatus.

FIG. 4 is a back view of the second applicator apparatus.

Like reference numbers and designations in the various drawings indicate like elements.

### DETAILED DESCRIPTION

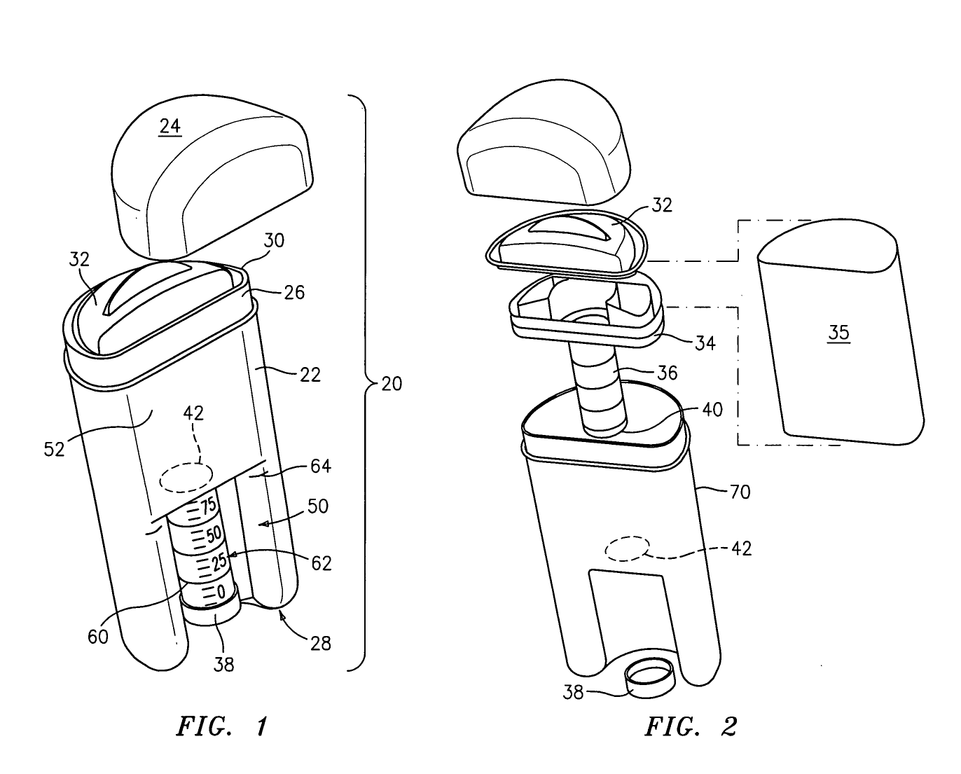

FIG. 1 shows an applicator 20 having a barrel 22 and a cover 24 in a removed position off a barrel neck 26 (an installed position being over the neck). The barrel and cover may each be unitarily molded (e.g., of a plastic material). The barrel extends from a bottom (base) end 28 to an upper end formed by a rim 30. A discardable undercap/seal 32 may be plugged into the neck and contain the composition (if required when filling the applicator). A foraminate applicator (not shown) may alternatively be secured across the barrel upper end for applying gel compositions. A platform 34 (FIG. 2) supports the composition 35.

A tubular shaft 36 depends from the underside of the platform and may be unitarily formed therewith (e.g., of a molded plastic material). As is discussed in further detail below, a cover 38 or an equivalent plug may close the open lower end 40 of the shaft 36. The shaft 36 passes through an aperture 42 in the barrel 22. A distal portion of the shaft 36 thus protrudes beyond the aperture. In the exemplary embodiment of FIG. 1, the shaft 36 has an essentially circular transverse cross-section and the aperture 42 is essentially complementary. The aperture 42 is at an intermediate position along the height of the barrel. The aperture is open to a recessed area 50 in the front face 52 of the barrel, leaving adjacent barrel portions at either side extending down to the bottom end 28. The exemplary recess 50 is also open at the bottom end, permitting a user to engage the shaft (such as via pressing a finger against the bottom end of the cap 38) when the shaft distal end is in close proximity to the bottom end 28.

Along its exterior sidewall surface, the shaft 36 bears indicia including exemplary registration lines 60 and associated numbers 62. Exemplary indicia 62 and 60 are molded-in-place and/or applied via painting or as a label/decal. Exemplary lines and numbers identify a percentage of the usable composition remaining in the applicator 20. In operation, with the seal 32 removed, the user may press upward on the shaft 36 to progressively raise the platform toward the barrel upper end/rim 30 so as to discharge the composition 25. As the barrel is raised, various of the registration lines may come into alignment with a corresponding registration feature on the barrel. One example of a corresponding registration feature is the aperture 42. Another is a registration line 64 (e.g., molded-in-place and/or applied as a paint or applied as a label/decal). As more and more of the composition 25 is consumed, the shaft distal end and cap 38 will progressively move upward along the recess 50. In the exemplary embodiment, the back/rear face 70 of the barrel is essentially continuous, lacking such a recess. However, a similar or different recess could be provided on that side.

To assemble and fill the applicator, the platform is inserted downward through the barrel upper end to an essentially bottomed position with the shaft 36 passing through the aperture 42. The seal 32 is then installed. In an inverted orientation, liquid composition material may be introduced through the shaft distal end 40. The material is permitted to harden (e.g., via cooling from a previously-elevated temperature). During this process, the underside of the seal 32 forms a mold, shaping the top surface of the ultimate composition body. After solidification, the shaft end cap 38 may be installed. The cap 38 provides a smooth surface for contact by the user's finger. The cover 24 may then be installed. If not already applied, a label, decal, or paint may be applied to the barrel and/or cover 24 containing appropriate information including trademarks, instructions, an identification of antiperspirant and/or deodorant status, legal information, and the like.

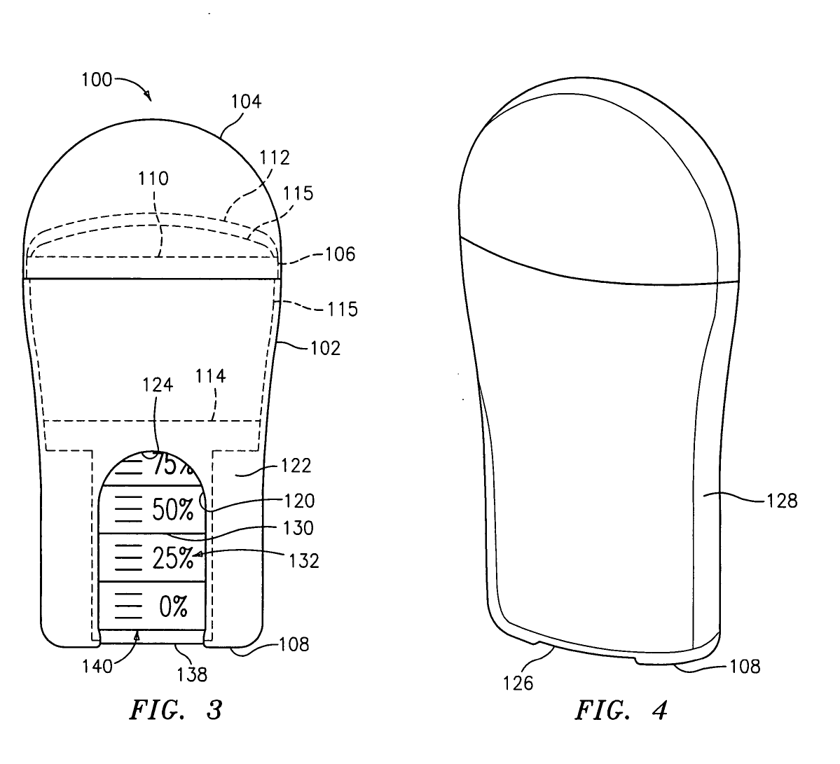

FIGS. 3 and 4 show an alternate implementation of an applicator 100 having a barrel 102 and a cover 104 shown in an installed position on the barrel neck 106. The barrel extends from a bottom end 108 to an upper end formed by a rim 110. A foraminate applicator or a discardable seal is schematically shown as 112. A platform 114 supports the composition 115. A shaft 116 depends from the platform 114 and may be unitarily formed therewith. The exemplary shaft 116 is of a slightly rounded rectangular transverse section.

The exemplary barrel 102 includes an aperture 120 extending along the front face 122 and bottom end 108. Along the front face, the aperture 120 is vertically elongate extending downward from a rounded upper end 124. The exemplary aperture 120 extends to a second end 126 (FIG. 4) near a junction of the bottom end 108 and a rear face 128. Alternatively, however, the aperture may extend along the rear face as it does on the front. However, by extending only along one of the faces, the chances for accidental movement of the platform during handling are reduced. In this implementation, the aperture 120 itself defines a recess between adjacent side portions of the barrel. The linear and numerical indicia 130 and 132 may be formed on the shaft and/or platform. The user may lift the platform by placing a finger against a plug 138 in a shaft lower end 140.

One or more embodiments of the present invention have been described. Nevertheless, it will be understood that various modifications may be made without departing from the spirit and scope of the invention. For example, the principles may be applied in a redesigning/engineering of any of a variety of existing applicators or in the design/engineering of yet new applicators. The illustrated or similar combinations of registration features may be reversed (e.g., an array of linear indicia and percentages along the barrel, with a single registration feature formed on or as a portion of the platform, shaft, or associated movable component or part). Other forms of recesses may be provided. Barrels lacking the recesses and/or including transparent windows for viewing the indicia may be provided. Accordingly, other embodiments are within the scope of the following claims.

What is claimed is:

1. A personal care applicator apparatus comprising:
a barrel having:
a bottom end;
a top end;
a front face;
a back face;
a recess in at least one of the front and back faces; and
an aperture open to the recess;
a platform upwardly moveable within the barrel from a first position to a second position; and
a plurality of indicia representative of a plurality of positions of the platform.

2. The apparatus of claim 1 further comprising:
an actuator shaft, coupled to the piston and extending through the aperture into the recess and having a bottom surface accessible by a user to push the piston upward to shift the piston upward, the indicia being on the actuator shaft.

3. The apparatus of claim 2 wherein:
at least a major portion of the platform and a major portion of the shaft are unitarily formed with each other as a common molding; and
the barrel is molded.

4. The apparatus of claim 2 wherein:
the recess is positioned to accommodate a finger of the user during pushing of the piston bottom surface.

5. The apparatus of claim 1 wherein:
the indicia comprise a longitudinal array of a plurality of molded-in-place rule lines.

6. The apparatus of claim 1 further comprising:
a solid stick of at least one of an underarm antiperspirant and underarm deodorant atop the piston; and
a removable cap over the barrel upper end.

7. The apparatus of claim 1 further comprising:
a gel body of at least one of an underarm antiperspirant and underarm deodorant atop the platform;
a foraminate applicator secured to the barrel proximate the upper end; and
a removable cap over the barrel upper end and applicator.

8. The apparatus of claim 7 wherein the cap has essentially front-to-back symmetry.

9. The apparatus of claim 7 wherein the barrel has essentially front-to-back symmetry.

10. An apparatus comprising:
a non-liquid composition of at least one of an underarm antiperspirant and underarm deodorant;
a barrel at least partially containing the composition; and
means for progressively raising the composition through an outlet of the barrel including means for indicating a remaining amount of the composition.

11. The apparatus of claim 10 further comprising:
a removable cap over a discharge end of the barrel.

12. The apparatus of claim 10 wherein the means for indicating comprise:
a plurality of rule lines on the means for progressively raising; and
a plurality of percentage-designating numerals on the means for progressively raising.

13. The apparatus of claim 10 wherein the barrel comprises:
means for accommodating a finger of a user during the raising.

14. A personal care apparatus comprising:
a barrel;
a personal care composition within the barrel;
a platform translatable to progressively expel the composition from the barrel; and
a plurality of indicia representative of a plurality of positions of the platform.

15. The apparatus of claim 14 wherein the composition comprises at least one of antiperspirant and deodorant.

16. The apparatus of claim 14 wherein the plurality of indicia are representative of a remaining quantity of the composition.

17. The apparatus of claim 14 wherein the barrel comprises a recess for accommodating a finger of a user during movement of the platform.
